(19) United States
(12) Patent Application Publication
(10) Pub. No.: US 2009/0274590 A1
(43) Pub. Date: Nov. 5, 2009

(54) PLASMA REACTOR ELECTROSTATIC CHUCK HAVING A COAXIAL RF FEED AND MULTIZONE AC HEATER POWER TRANSMISSION THROUGH THE COAXIAL FEED

(75) Inventors: MICHAEL D. WILLWERTH, Campbell, CA (US); David Palagashvili, Mountain View, CA (US); Brian K. Hatcher, San Jose, CA (US); Alexander M. Paterson, San Jose, CA (US); Douglas A. Buchberger, JR., Livermore, CA (US)

Correspondence Address: LAW OFFICE OF ROBERT M. WALLACE, 2112 EASTMAN AVENUE, SUITE 102, VENTURA, CA, 93003, US

(73) Assignee: Applied Materials, Inc., Santa Clara, CA (US)

(21) Appl. No.: 12/142,640

(22) Filed: Jun. 19, 2008

Related U.S. Application Data
(60) Provisional application No. 61/126,611, filed on May 5, 2008.

(51) Int. Cl. H05H 1/24

(52) U.S. Cl. 422/186.04

(57) ABSTRACT

A workpiece support pedestal includes an insulating puck having a workpiece support surface, a conductive plate underlying the puck, the puck containing electrical utilities and thermal media channels, and an axially translatable coaxial RF path assembly underlying the conductive plate. The coaxial RF path assembly includes a center conductor, a grounded outer conductor and a tubular insulator separating the center and outer conductors, whereby the puck, plate and coaxial RF path assembly comprise a movable assembly whose axial movement is controlled by a lift servo. Plural conduits extend axially through the center conductor and are coupled to the thermal media utilities. Plural electrical conductors extend axially through the tubular insulator and are connected to the electrical utilities.

### CROSS-REFERENCE TO RELATED APPLICATIONS

This application claims the benefit of U.S. Provisional Application Ser. No. 61/126,611, filed May 5, 2008.

### BACKGROUND

There is a need for a movable cathode or wafer support pedestal by which the gap or distance between the workpiece or semiconductor wafer and the ceiling can be adjusted by as much as several inches, for a 300 mm wafer diameter. One of the reasons for this need is that certain process parameters may be improved for a given process by changing the wafer-ceiling gap. There is a further need to efficiently couple RF bias power to the cathode. There is another need to transmit AC power to independent inner and outer heater elements within the cathode through pairs of supply and return AC electrical conductors. There is a yet further need to provide supply and return conduits carrying helium gas to backside cooling channels in the wafer support surface of the cathode. There a still further need to provide supply and return conduits carrying coolant for coolant passages within the cathode. There is a need to provide a conductor for carrying high voltage DC power to an electrostatic clamping (chucking) electrode that is in the cathode. The various conduits and electrical conductors must be electrically compatible with the transmission of high levels RF power to the cathode while at the same time allowing for controlled axial movement of the cathode over a large range of several (e.g., four) inches.

### SUMMARY

A workpiece support pedestal is provided within a plasma reactor chamber. The pedestal includes an insulating puck having a workpiece support surface, a conductive plate underlying the puck, the puck containing electrical utilities and thermal media channels, and an axially translatable coaxial RF path assembly underlying the conductive plate. The coaxial RF path assembly includes a center conductor, a grounded outer conductor and a tubular insulator separating the center and outer conductors, whereby the puck, plate and coaxial RF path assembly comprise a movable assembly whose axial movement is controlled by a lift servo. Plural conduits extend axially through the center conductor and are coupled to the thermal media utilities. Plural electrical conductors extend axially through the tubular insulator and are connected to the electrical utilities.

### BRIEF DESCRIPTION OF THE DRAWINGS

So that the manner in which the exemplary embodiments of the present invention are attained and can be understood in detail, a more particular description of the invention, briefly summarized above, may be had by reference to the embodiments thereof which are illustrated in the appended drawings. It is to be appreciated that certain well known processes are not discussed herein in order to not obscure the invention.

FIG. 1 depicts a plasma reactor in accordance with one embodiment.

FIG. 2 is a cross-sectional elevational view of a wafer support pedestal of the plasma reactor of FIG. 1.

FIG. 3 is an enlarged view of a portion of the top of the wafer support pedestal of FIG. 2.

FIG. 4 is a cross-sectional plan view taken along line 4-4 of FIG. 2.

FIG. 5 is a cross-sectional plan view taken along line 5-5 of FIG. 2.

To facilitate understanding, identical reference numerals have been used, where possible, to designate identical elements that are common to the figures. It is contemplated that elements and features of one embodiment may be beneficially incorporated in other embodiments without further recitation. It is to be noted, however, that the appended drawings illustrate only exemplary embodiments of this invention and are therefore not to be considered limiting of its scope, for the invention may admit to other equally effective embodiments.

### DETAILED DESCRIPTION

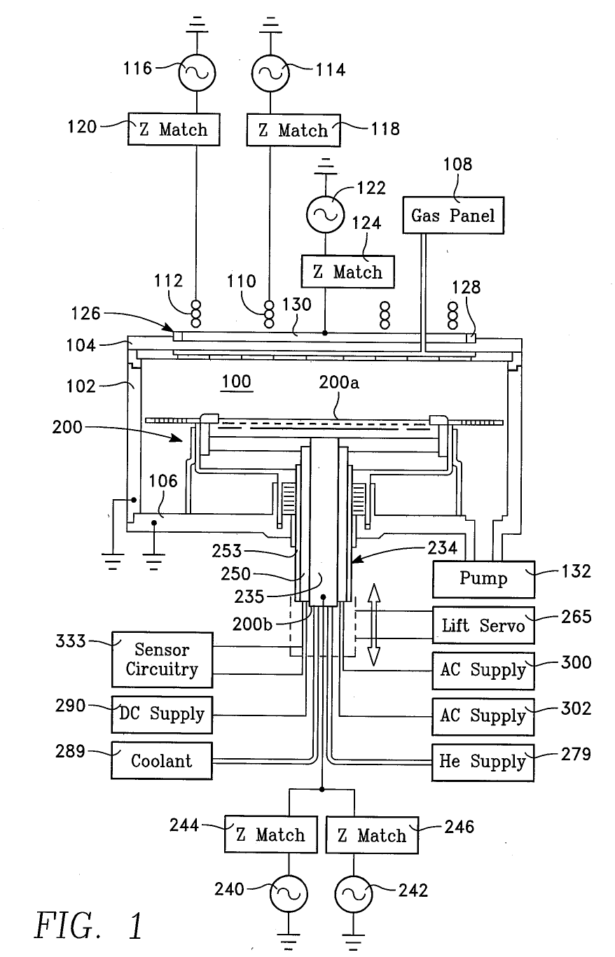

Referring to FIG. 1, a plasma reactor has a chamber 100 defined by a cylindrical sidewall 102, a ceiling 104 and a floor 106 whose peripheral edge meets the sidewall 102. The ceiling 104 may be a gas distribution plate that received process gas from a process gas supply 108. Plasma RF source power may be inductively coupled into the chamber 100 from respective inner and outer coil antennas 110, 112 that are connected to respective RF source power generators 114, 116 through respective RF impedance match elements 118, 120. The ceiling or gas distribution plate 104 may be formed of a non-conductive material in order to permit inductive coupling of RF power from the coil antennas 110, 112 through the ceiling 104 and into the chamber 100. Alternatively, or in addition, RF plasma source power from another RF generator 122 and impedance match 124 may be capacitively coupled from an overhead electrode 126. In order to permit inductive coupling into the chamber 100 of RF power from the coil antennas 110, 112, the overhead electrode 126 is provided in the form of a Faraday shield of the type well-known in the art consisting of an outer ring conductor 128 and plural conductive fingers 130 extending radially inwardly from the outer ring conductive 128. Alternatively, in the absence of the coil antennas 110, 112, the ceiling 104 may be formed of metal and serve as the overhead electrode connected to the RF generator 122 through the impedance match 124. The sidewall 104 and floor 106 may be formed of metal and connected to ground. A vacuum pump 132 evacuates the chamber 100 through the floor 106.

A wafer support pedestal 200 is provided inside the chamber 100 and has a top wafer support surface 200a and a bottom end 200b below the floor 106. RF bias power is coupled through the pedestal bottom 200b to a cathode electrode (to be described) below the top surface 200a through a coaxial feed functioning as an RF transmission line. The coaxial feed, which is described in detail below, includes an axially movable coaxial assembly 234 consisting of a cylindrical inner conductor 235 surrounded by an annular insulator layer 250 and an outer annular conductor 253 surrounding the annular insulator layer 250. As will be described in detail below, plural coolant conduits and plural gas conduits (not shown in FIG. 1) within the center conductor provide supply and return paths for coolant and helium gas from the pedestal bottom 200b to coolant passages underneath the wafer support surface 200a and to backside helium channels in the wafer support surface 200a, respectively. Electrical lines (not shown in FIG. 1) extend from the pedestal bottom 200b through the above-mentioned annular insulator layer to carry AC power to internal heaters below the pedestal top surface 200a, DC power to an internal chucking electrode below the top surface 200a and to carry optical temperature probe signals from the sensors at the top surface 200a and out through the pedestal bottom 200b. The internal structure of the pedestal 200 will now be described in detail.

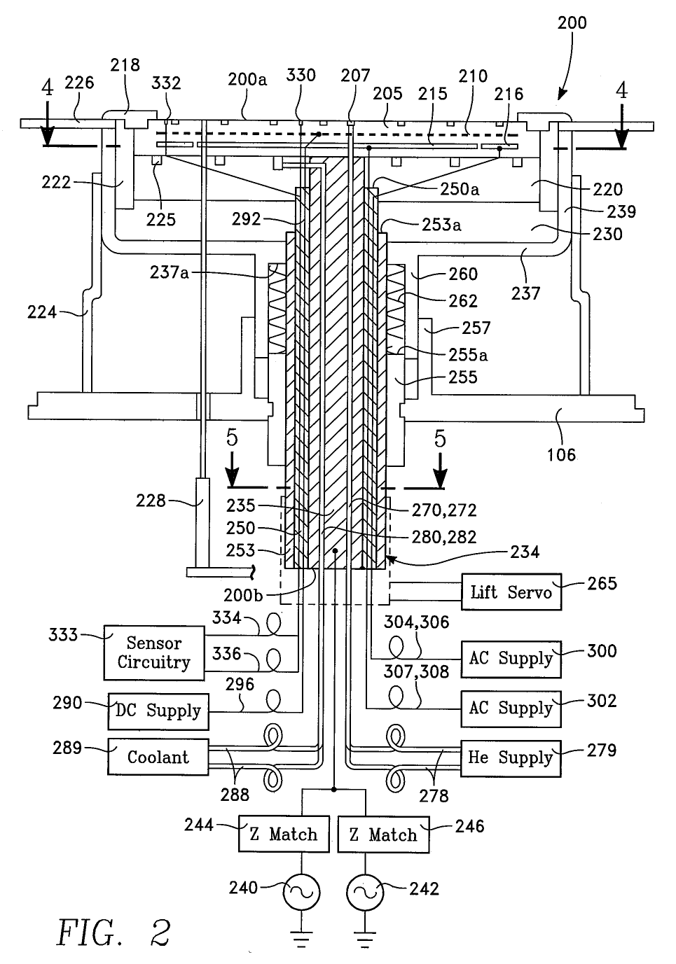

Referring to FIG. 2, the pedestal 200 includes elements mechanically coupled to the coaxial movable assembly 234 and which therefore elevate and depress with the movable assembly 234. The elements mechanically coupled to the movable assembly include a disk-shaped insulating puck or top layer 205 forming the top wafer support surface 200a, and may be formed of aluminum nitride, for example. The puck 205 contains an internal chucking electrode 210 close to the top surface 200a. The puck 205 also contains inner and outer electrically resistive heating elements 215, 216. Underlying the puck 205 is a disk-shaped metal plate 220, which may be formed of aluminum. The wafer support surface 200a is the top surface of the puck 205 and has open channels 207 through which a thermally conductive gas such as helium is pumped to govern thermal conductivity between the backside of a wafer being processed on the support surface 200a and the puck 205. Internal coolant passages 225 are provided in the puck 205 or alternatively in the plate 220. A disk-shaped quartz insulator or planar insulator layer 230 underlies the metal plate 220. A conductive support dish 237 underlies the insulator 230 and may support a cylindrical wall 239 surrounding the insulator 230, the plate 220 and the puck 205. The puck 205, the metal plate 220, the insulator layer 230 and the support dish 237 are elements of the pedestal 200 which elevate and depress with the movable coaxial assembly 234, and are mechanically coupled to the movable coaxial assembly 234 as follows: the support dish 237 engages the coaxial outer conductor 253; the insulator 230 engages the coaxial insulator sleeve 250; the metal plate 220 engages the coaxial inner conductor 235.

The coaxial inner conductor 235 is configured as an elongate stem or cylindrical rod extending from the pedestal bottom 200b through the metal plate 220. The bottom end of the stem 235 is connected to one or both of two RF bias power generators 240, 242, through respective RF impedance match elements 244, 246. The stem 235 conducts RF bias power to the plate 220, and the plate 220 functions as an RF-hot cathode electrode. An annular insulator layer or sleeve 250 surrounds the inner conductor or stem 235. An annular outer conductor 253 surrounds the insulator sleeve 250 and the inner conductor 235, the coaxial assembly 235, 250, 253 being a coaxial transmission line for the RF bias power.

The outer conductor 253 is constrained by a tubular stationary guide sleeve 255 connected to the floor 106. A movable tubular guide sleeve 260 extending from the support dish 237 surrounds the stationary guide sleeve 255. An outer stationary guide sleeve 257 extending from the floor 106 constrains the movable guide sleeve 260. A bellows 262 confined by the movable guide sleeve 260 is compressed between a top surface 255a of the stationary guide sleeve 255 and a bottom surface 237a of the dish 237.

A lift servo 265 anchored to the frame of the reactor (e.g., to which the sidewall 102 and floor 106 are anchored) is mechanically linked to the movable coaxial assembly 234 and elevates and depresses the axial position of the movable coaxial assembly 234. The floor 106, the sidewall 102, the servo 265 and the stationary tube 255 form a stationary assembly.

A grate 226 extends from the pedestal side wall 239 toward the chamber side wall 102 (FIG. 1). Referring still to FIG. 2, a process ring 218 overlies the edge of the puck 205. An insulation ring 222 provides electrical insulation between the plate 220 and the pedestal side wall 239. A skirt 224 extends from the floor and surrounds the pedestal side wall 239. Lift pins 228 extend through the floor 106, the dish 237, the insulator plate 230, the metal plate 220 and the puck 205.

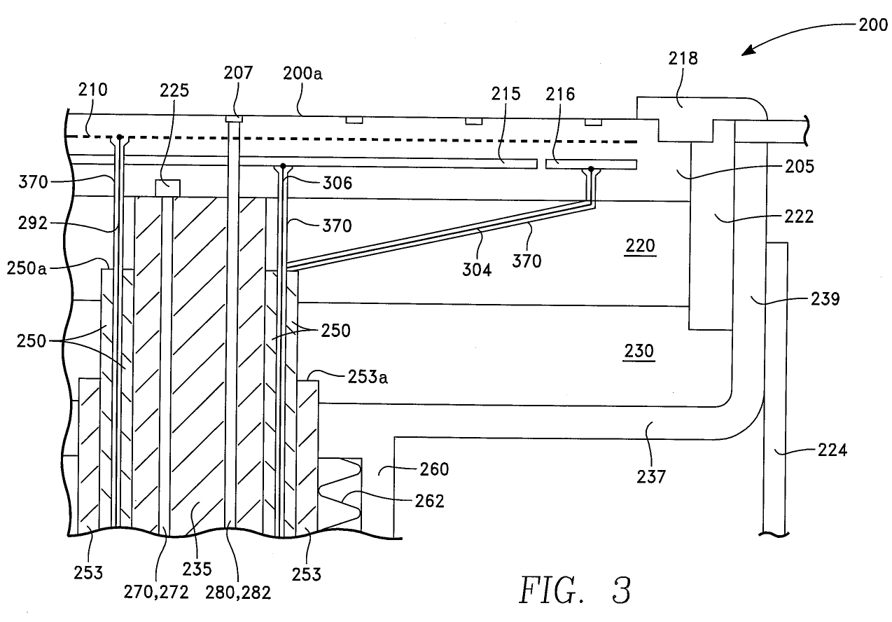

Referring now to FIG. 3, in one embodiment the outer conductor 253 has its top end 253a spaced sufficiently below the aluminum plate 220 to avoid electrical contact between them. As shown in FIG. 3, the coaxial insulator 250 has its top end 250a spaced sufficiently below the puck 205 to permit electrical contact between the coaxial center conductor 235 and the aluminum plate 220.

Referring again to FIG. 2, the outer conductor 253 of the coaxial assembly is grounded through the stationary guide sleeve 255 contacting the grounded floor 106. The movable guide sleeve 260 and the pedestal skirt 224 and support dish 237 are also grounded by contact between the movable sleeve 260 with the stationary guide sleeve 255.

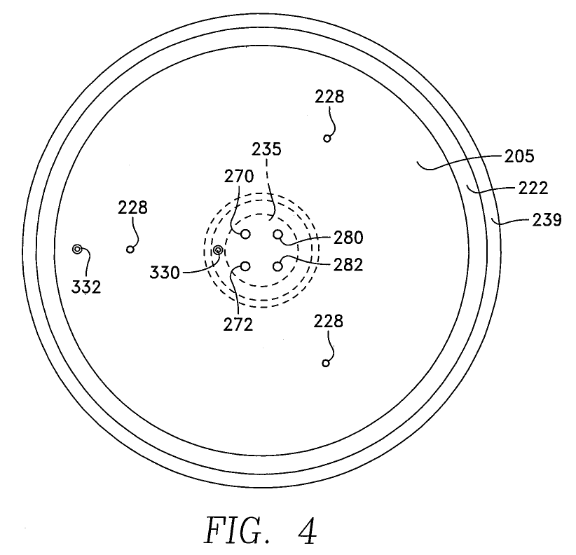

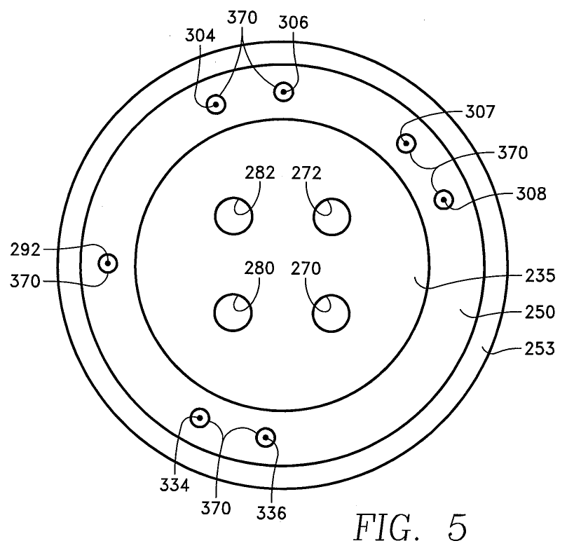

Referring now to FIG. 2 and the cross-sectional views of FIGS. 4 and 5, a pair of helium conduits 270, 272 extend axially through the stem or inner conductor 235 from the bottom 200b to the top surface of the stem 235 where it interfaces with the facilities plate 220. The helium conduits 270, 272 communicate with the backside helium channels 207 in the wafer support surface 200a of the puck 205. Flex hoses 278 provide connection at the movable stem bottom 200b between the gas conduits 270, 272 and a stationary helium gas supply 279.

A pair of coolant conduits 280, 282 extend axially through the stem or inner conductor 235 through the stem 235 to communicate with the internal coolant passages 225. Flex hoses 288 provide connection at the movable stem bottom 200b between the coolant conduits 280, 282 and a stationary coolant supply 289.

Connection between a D.C. wafer clamping voltage source 290 and the chucking electrode 210 is provided by a conductor 292 extending axially within the annular insulator 250, and extending through the puck 205 to the chucking electrode 210. A flexible conductor 296 provides electrical connection at the movable at the stem bottom 200b between the conductor 292 and the stationary D.C. voltage supply 290.

Connection between the inner heater element 215 and a first stationary AC power supply 300 is provided by a first pair of AC power conductor lines 304, 306 extending axially from the stem bottom 200b and through the insulation sleeve 250.

Connection between the outer heater element 216 and a second stationary AC power supply 302 is provided by a first pair of AC power conductor lines 307, 308 extending axially from the stem bottom 200b and through the insulation sleeve 250. The AC lines 307, 308 further extend radially through the puck 205 to the outer heater element 216.

In one embodiment, an inner zone temperature sensor 330 extends through an opening in the wafer support surface 200a and an outer zone temperature sensor 332 extends through another opening in the wafer support surface 200a. Electrical (or optical) connection from the temperature sensors 330, 332 to sensor electronics 333 is provided at the stem bottom 200b by respective electrical (or optical) conductors 334, 336 extending from the stem bottom 200b through the insulator sleeve 250 and through the puck 205. The conductor 336 extends radially through the puck 205 to the outer temperature sensor 332.

Referring to FIGS. 3 and 5, those portions of the electrical conductors 292, 304, 306, 307, 308, 334, 336 lying within the aluminum plate 220 are surrounded by individual electrically insulating cylindrical sleeves 370. These arrangements are optional and other implementations may be constructed to enable electrical connection between the center conductor 235 and the plate 220 while providing insulation of the electrical conductors 292, 304, 306, 307, 308, 334, 336.

While the foregoing is directed to embodiments of the present invention, other and further embodiments of the invention may be devised without departing from the basic scope thereof, and the scope thereof is determined by the claims that follow.

What is claimed is:

1. A workpiece support pedestal for using within a plasma reactor chamber, said pedestal comprising:
(A) an insulating puck having a workpiece support surface;
(B) a conductive plate underlying said puck, said puck containing electrical utilities and thermal media channels;
(C) an axially translatable coaxial RF path assembly underlying said conductive plate and comprising a center conductor, a grounded outer conductor and a tubular insulator separating said center and outer conductors, whereby said puck, plate and coaxial RF path assembly comprise a movable assembly;
(D) a lift servo coupled to said coaxial assembly for axial translation thereof;
(F) plural conduits extending axially through said center conductor and coupled to said thermal media utilities;
(G) plural electrical conductors extending axially through said tubular insulator and connected to said electrical utilities.

2. The apparatus of claim 1 further comprising a flexible RF conductor connected to a bottom end of said center conductor and connectable to an RF power source.

3. The apparatus of claim 1 wherein said thermal media utilities comprise gas flow channels in said workpiece support surface, said plural conduits comprising a gas supply and return conduits coupled to said gas flow channels.

4. The apparatus of claim 3 wherein said thermal media utilities comprise coolant flow channels, wherein said plural conduits further comprise coolant supply and return conduits coupled to said coolant flow channels.

5. The apparatus of claim 3 wherein said electrical utilities comprise a chucking electrode and inner and outer concentric heating elements, said electrical conductors comprising a D.C. supply conductor connected to said chucking electrode, a first pair of A.C. conductors coupled to said inner heating element and a second pair of A.C. conductors coupled to said outer heating element.

6. The apparatus of claim 5 wherein said electrical utilities further comprise radially inner and outer temperature sensors in said workpiece support surface, and wherein said electrical conductors comprise at least a first conductor connected to said radially inner temperature sensor and at least a second conductor connected to said radially outer temperature sensor.

7. The apparatus of claim 5 further comprising radially inner and outer temperature sensors in said workpiece support surface, and optical conductors coupled to said inner and outer temperature sensors, said optical conductors extending axially through said coaxial RF path assembly.

8. The apparatus of claim 7 wherein said optical conductors extend axially through said tubular insulator.

9. The apparatus of claim 1 wherein said outer conductor of said coaxial path assembly terminates below said conductive plate so as to be electrically isolated therefrom.

10. The apparatus of claim 9 wherein said electrical conductors pass through said conductive plate, said apparatus further comprising insulator sleeves surrounding the individual electrical conductors within said conductive plate.

11. A plasma reactor comprising:
a chamber having a sidewall, a ceiling and a floor;
an RF power source comprising an RF generator and an RF impedance match;
a workpiece support pedestal within the chamber comprising:
(A) an insulating puck having a workpiece support surface;
(B) a conductive plate underlying said puck, said puck containing electrical utilities and thermal media channels;
(C) an axially translatable coaxial RF path assembly underlying said conductive plate and comprising a center conductor having a top end contacting said conductive plate and a bottom end connected to said RF power source, a grounded outer conductor and a tubular insulator separating said center and outer conductors, whereby said puck, plate and coaxial RF path assembly comprise a movable assembly;
(D) a lift servo coupled to said coaxial assembly for axial translation thereof;
(F) plural conduits extending axially through said center conductor and coupled to said thermal media utilities;
(G) plural electrical conductors extending axially through said tubular insulator and connected to said electrical utilities.

12. The apparatus of claim 11 further comprising a flexible RF conductor connected to a bottom end of said center conductor and connectable to an RF power source.

13. The apparatus of claim 11 wherein said thermal media utilities comprise gas flow channels in said workpiece support surface, said plural conduits comprising a gas supply and return conduits coupled to said gas flow channels.

14. The apparatus of claim 13 wherein said thermal media utilities comprise coolant flow channels, wherein said plural conduits further comprise coolant supply and return conduits coupled to said coolant flow channels.

15. The apparatus of claim 13 wherein said electrical utilities comprise a chucking electrode and inner and outer concentric heating elements, said electrical conductors comprising a D.C. supply conductor connected to said chucking electrode, a first pair of A.C. conductors coupled to said inner heating element and a second pair of A.C. conductors coupled to said outer heating element.

16. The apparatus of claim 15 wherein said electrical utilities further comprise radially inner and outer temperature sensors in said workpiece support surface, and wherein said electrical conductors comprise at least a first conductor connected to said radially inner temperature sensor and at least a second conductor connected to said radially outer temperature sensor.

17. The apparatus of claim 15 further comprising radially inner and outer temperature sensors in said workpiece support surface, and optical conductors coupled to said inner and outer temperature sensors, said optical conductors extending axially through said coaxial RF path assembly.

18. The apparatus of claim 1 wherein:
said movable assembly further comprises:
a planar insulator layer underlying said conductive plate;
a dish underlying said insulator layer and an axial annular skirt extending downwardly from said dish and being concentric with said outer conductor of said coaxial path assembly, and defining an annular space between said skirt and said outer conductor;
said reactor further comprises:
a stationary axial guide sleeve coupled to said floor and surrounding said outer conductor and partially extending into said annular space, said axial annular skirt surrounding said stationary axial guide sleeve.
